(19) United States
(12) Patent Application Publication
(10) Pub. No.: US 2024/0114545 A1
(43) Pub. Date: Apr. 4, 2024

(54) WIRELESS MODEM, MOBILE DEVICE AND METHOD FOR WIRELESS COMMUNICATION

(71) Applicant: MEDIATEK Inc., Hsinchu City (TW)

(72) Inventors: Yu-Ting SUN, Hsinchu City (TW); Wan-Ting HUANG, Hsinchu City (TW); I-Ching HSIEH, Hsinchu City (TW)

(21) Appl. No.: 18/479,157

(22) Filed: Oct. 2, 2023

Related U.S. Application Data
(60) Provisional application No. 63/412,543, filed on Oct. 3, 2022.

(51) Int. Cl. H04W 72/56; H04B 17/382; H04W 72/542

(52) U.S. Cl. CPC H04W 72/56; H04B 17/382; H04W 72/542

(57) ABSTRACT

A method, a wireless modem and a mobile device for wireless communication are provided. The method for wireless communication includes: judging a plurality of service types for a plurality of cells; judging a plurality of gears for each of the service types; obtaining a customization favor setting; obtaining a plurality of weighted priority values for the plurality of cells according to the plurality of service types and the customization favor setting; obtaining a plurality of weighted signal quality values for the plurality of cells according to the plurality of service types, the plurality of gears for each of the plurality of service types and the customization favor setting; in an idle mode, triggering mobility via cell reselection which uses the weighted priority values or the weighted signal quality values; and in a connected mode, triggering mobility via measurement reports which are generated based on the weighted signal quality values.

This application claims the benefit of U.S. Provisional application Ser. No. 63/412,543, filed Oct. 3, 2022, the disclosure of which is incorporated by reference herein in its entirety.

### TECHNICAL FIELD

The disclosure relates in general to a wireless modem, a mobile device and a method, and more particularly to a wireless modem, a mobile device and a method for wireless communication.

### BACKGROUND

Over the years, mobile communication systems have grown exponentially. The 3rd generation partnership project (3GPP) is currently carrying out the standardization of the fifth generation (5G system, 5GS) including the core network and access network, 3GPP. It has developed the most successful standard technologies in the mobile communications market such as Universal Mobile Telecommunication System (UMTS) and Long Term Evolution (LTE).

The mobile device performs reselection according to the idle mode priority and cell reselection threshold setting in the New Radio (NR)/LTE specification. The priority is set, for example, via system information block (SIB), dedicated priority, deprioritization, alternative sib priority. The priority adjustment is performed based on some specification condition and logic, such as multimedia broadcast multicast service (MBMS), closed subscriber group (CSG), Closed Access Group (CAG).

Cell reselection behavior will basically follow cell signal quality value (ex: reference signal received power (RSRP), reference signal received quality (RSRQ), signal to interference noise ratio (SINR)) and priority/threshold setting from network, but cannot guarantee best user experience.

Besides, the mobile device performs A3/A4/A5 report according to network measurement configuration setting in the NR/LTE specification.

Handover mobility behavior will basically follow cell signal value and network's offset/threshold setting, but cannot guarantee best user experience.

### SUMMARY

The disclosure is directed to a wireless modem, a mobile device and a method for wireless communication. The user purpose is considered to perform the cell reselection behavior in the idle mode and to perform the handover behavior in the connected mode. As such, the mobile device could guarantee best user experience. Moreover, even if the user has multiple purposes, weighted values could be used to consider the multiple purposes at the same time to solve the conflict between the multiple purposes.

According to one embodiment, a method for wireless communication includes: judging a plurality of service types for a plurality of cells; judging a plurality of gears for each of the service types; obtaining a customization favor setting; obtaining a plurality of weighted priority values for the plurality of cells according to the plurality of service types and the customization favor setting; obtaining a plurality of weighted signal quality values for the plurality of cells according to the plurality of service types, the plurality of gears for each of the plurality of service types and the customization favor setting; in an idle mode, triggering mobility via cell reselection which uses the weighted priority values or the weighted signal quality values; and in a connected mode, triggering mobility via measurement reports which are generated based on the weighted signal quality values.

According to another embodiment, a wireless modem for wireless communication is provided. The wireless modem includes a service judger, a customization center, a priority analyzer, a signal quality analyzer, a first controller and a second controller. The service judger is configured to judge a plurality of service types for a plurality of cells and judge a plurality of gears for each of the service types. The customization center is configured to obtain a customization favor setting. The priority analyzer is configured to obtain a plurality of weighted priority values for the plurality of cells according to the plurality of service types and the customization favor setting. The signal quality analyzer is configured to obtain a plurality of weighted signal quality values for the plurality of cells according to the plurality of service types, the plurality of gears for each of the plurality of service types and the customization favor setting. The first controller is configured to trigger mobility in an idle mode via cell reselection which uses the weighted priority values or the weighted signal quality values. The second controller is configured to trigger mobility in a connected mode via measurement reports which are generated based on the weighted signal quality values.

According to an alternative embodiment, a mobile device is provided. The wireless modem includes a service judger, a customization center, a priority analyzer, a signal quality analyzer, a first controller and a second controller. The service judger is configured to judge a plurality of service types for a plurality of cells and judge a plurality of gears for each of the service types. The customization center is configured to obtain a customization favor setting. The priority analyzer is configured to obtain a plurality of weighted priority values for the plurality of cells according to the plurality of service types and the customization favor setting. The signal quality analyzer is configured to obtain a plurality of weighted signal quality values for the plurality of cells according to the plurality of service types, the plurality of gears for each of the plurality of service types and the customization favor setting. The first controller is configured to trigger mobility in an idle mode via cell reselection which uses the weighted priority values or the weighted signal quality values. The second controller is configured to trigger mobility in a connected mode via measurement reports which are generated based on the weighted signal quality values.

### BRIEF DESCRIPTION OF THE DRAWINGS

FIG. 1 shows a mobile device.

FIG. 2 shows a block diagram of a wireless modem according to one embodiment.

FIG. 3 illustrates the operation of a priority analyzer.

FIG. 4 illustrates the operation of a signal quality analyzer.

FIGS. 5A to 5B show a flowchart of a method for wireless communication.

FIG. 6 shows a detail flowchart of the step S140.

FIG. 7 shows a detail flowchart of the step S150.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

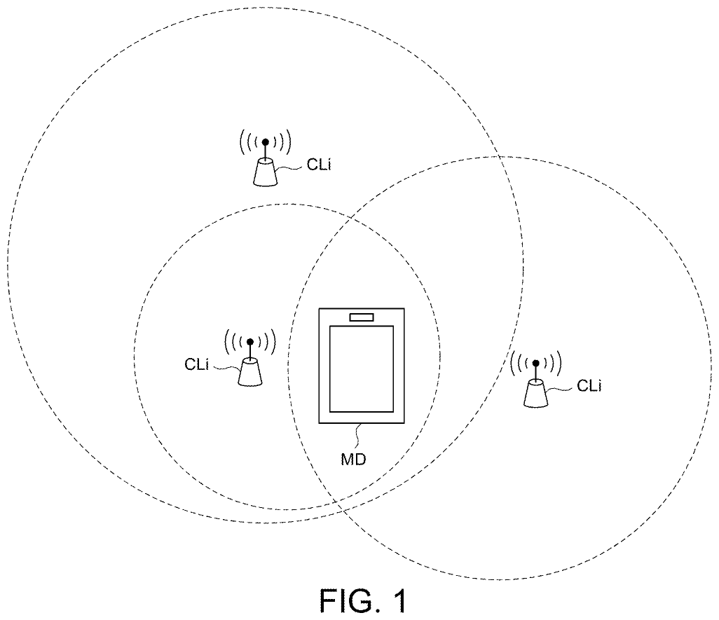

Please refer to FIG. 1, which shows a mobile device MD. The mobile device MD is, for example, a smart phone, a laptop, or a tablet computer. The mobile device MD may stay at one of the cells CLi. In one embodiment, the user may have preference for different purposes. For example, for the Icon display purpose, the mobile device MD may prefer to stay under ENDC/NR SA cells, rather than the LTE cells. For the power saving purpose, the mobile device MD may prefer to stay under power saving cells (ex: LTE cell, long DRX cell), rather than NR cells. For the game performance purpose, the mobile device may prefer to stay under low latency cells. For the high speed moving purpose, the mobile device MD may prefer to stay under HST dedicated cell, rather than cells with better cell signal quality. For the throughput performance purpose, the mobile device MD may prefer to stay under cells with better network resource allocation, rather than cells with better cell signal quality.

In this embodiment, the user purpose is considered to perform the cell reselection behavior in the idle mode and to perform the handover behavior in the connected mode. As such, the mobile device MD could guarantee best user experience.

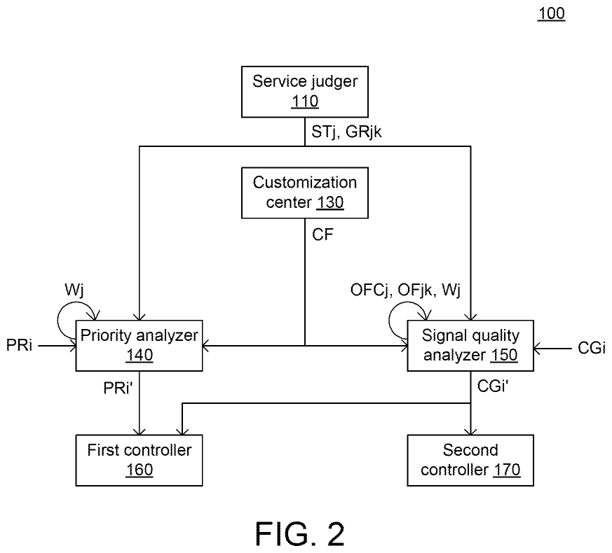

Please refer to FIG. 2 which shows a block diagram of a wireless modem 100 according to one embodiment. The wireless modem 100 is equipped in the mobile device MD. In this embodiment, the wireless modem 100 includes a service judger 110, a customization center 130, a priority analyzer 140, a signal quality analyzer 150, a first controller 160 and a second controller 170. The service judger 110, the customization center 130, the priority analyzer 140, the signal quality analyzer 150, the first controller 160 and/or the second controller 170 are/is, for example, a circuit, a chip, a firmware, a circuit board, a storage device storing a plurality of program codes. Based on the current situation, a customization favor setting CF could be obtained by the customization center 130. The customization favor setting CF is, for example, the preference of the icon display purpose, the power saving purpose, the game performance purpose, the high speed moving purpose or the throughput performance purpose. The customization favor setting CF may indicate that the power saving purpose is preferred over the game performance purpose. Or, the customization favor setting CF may indicate that the power saving purpose is most preferred among the icon display purpose, the power saving purpose, the game performance purpose, the high speed moving purpose and the throughput performance purpose.

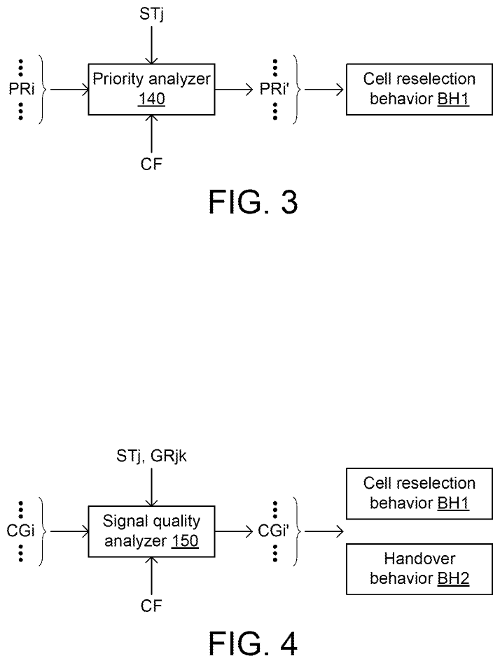

Please refer to FIG. 3, which illustrates the operation of the priority analyzer 140. The priority analyzer 140 is configured to adjust a plurality of priority values PRi for different cells CLi to be a plurality of weighted priority values PRi′ according to the customization favor setting CF. The weighted priority values PRi′ are then used to perform the cell reselection behavior BH1 in the idle mode. Based on the customization favor setting CF, the user purpose is considered to perform the cell reselection behavior BH1 in the idle mode, so the mobile device MD could guarantee best user experience.

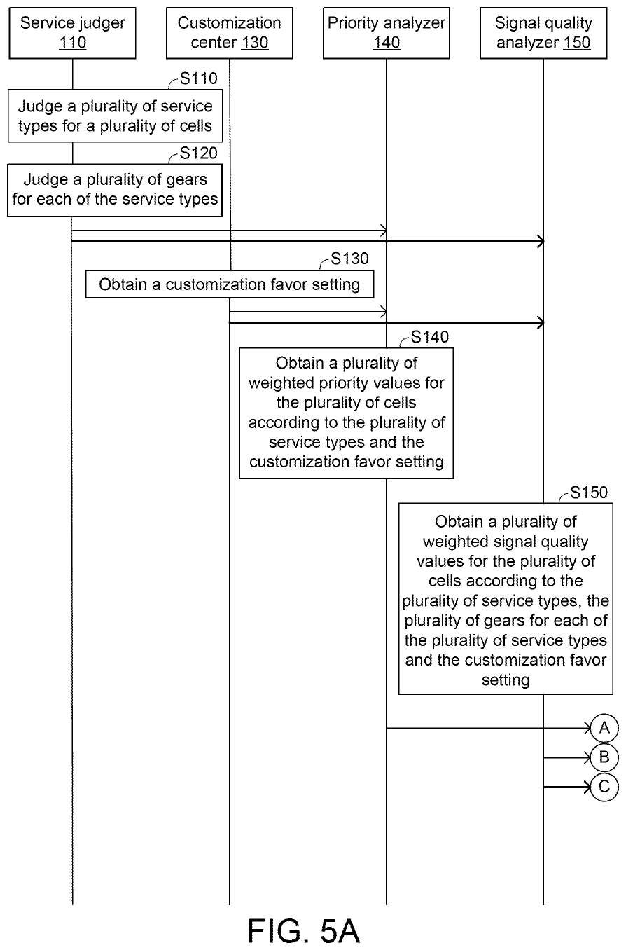

Please refer to FIG. 4, which illustrates the operation of the signal quality analyzer 150. The signal quality analyzer 150 is configured to adjust a plurality of signal quality values CGi, such as RSRP/RSRQ values, for different cells CLi to be a plurality of weighted signal quality values CGi′ according to the customization favor setting CF. The weighted signal quality values CGi′ are then used to perform the cell reselection behavior BH1 in the idle mode and/or the handover behavior BH2 in the connected mode. Based on the customization favor setting CF, the user purpose is considered to perform the cell reselection behavior BH1 in the idle mode and/or the handover behavior BH2 in the connected mode, so the mobile device MD could guarantee best user experience.

The detail of the operation of the above mentioned elements is described via a flowchart.

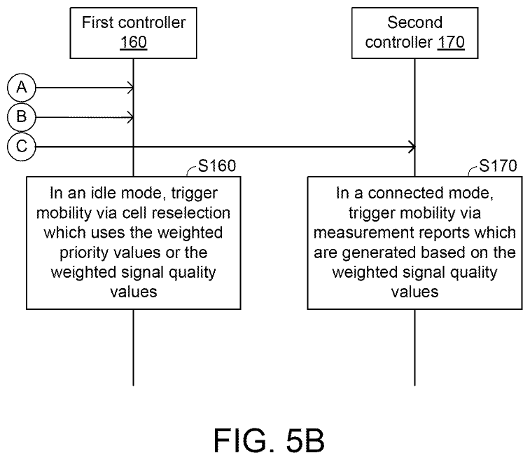

Please refer to FIGS. 5A to 5B, which show a flowchart of a method for wireless communication. The method for wireless communication includes steps S110 to S170. In the step S110, the service judger 110 judges a plurality of service types STj for the plurality of cells CLi. The service type STj is, for example, “power saving”, “game performance”, “Icon display”, “high speed moving” or “throughput performance.” Each of the cells CLi may correspond with one or more service types STj.

Next, in the step S120, the service judger 110 judges a plurality of gears GRjk for each of the service types STj. For example, the gears GRjk for “game performance” may include “gaming good cell”, “gaming normal cell” and “gaming bad cell.” The gears GRjk for “throughput performance” may include “throughput good cell”, “throughput normal” and “throughput bad cell.” Each of the cells CLi may correspond only one gear GRjk for the same service type STj.

Then, in the step S130, the customization center 130 obtains the customization favor setting CF. The customization favor setting CF is, for example, the Icon display purpose, the power saving purpose, the game performance purpose, the high speed moving purpose or the throughput performance purpose.

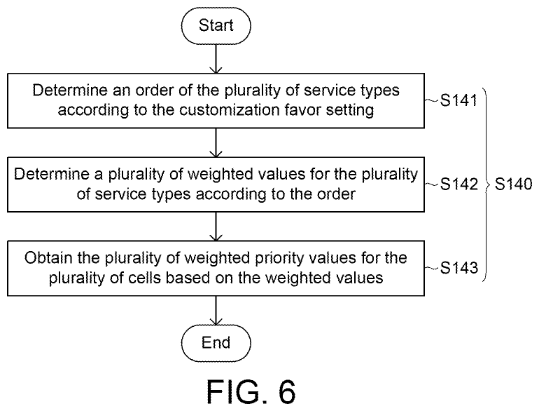

Afterwards, in the step S140, referring to the FIG. 3, the priority analyzer 140 analyzes and obtains the plurality of weighted priority values PRi′ for the plurality of cells CLi according to the plurality of service types STj and the customization favor setting CF. FIG. 6 shows a detail flowchart of the step S140. The step S140 includes steps S141 to S143.

In the step S141 of the FIG. 6, as shown in the following table I, the priority analyzer 140 determines an order of the plurality of service types STj according to the customization favor setting CF. The customization favor setting CF could be dynamically set by the user. In the example table I, the customization favor setting CF in the table I is that the power saving is preferred over the game performance.

TABLE I

| customization | | | |
|---|---|---|---|
| favor | | | |
| setting CF | | service types STj | weighted values |
| order | 1 | Power saving | +(bias + N) |
| | 2 | Game performance | +(bias + N − 1) |
| | 3 | . . . | +(bias + N − 2) |

Next, in the step S142 of the FIG. 6, as shown in the table I, the priority analyzer 140 determines a plurality of weighted values Wj for the plurality of service types STj according to the order. The plurality of weighted values Wj are different. For example, the weighted value Wj for “power saving” is “+(bias+N)”, the weighted value Wj for “game performance” is “+(bias+N-1).” The weighted values Wj are decremented based on the order.

Then, in the step S143 of the FIG. 6, as shown in the following table II, the priority analyzer 140 analyzes and obtains the plurality of weighted priority values PRi′ for the plurality of cells CLi based on the weighted values Wj. The priority value PRi for one cell CLi is defined via the specification. The weighted priority values PRi′ are calculated through the priority values PRi and the decremented weighted values Wj. For example, “NR cell-Game prefer frequency” corresponds “game performance”, so the weighted priority value PRi′ is “PRi+(bias+N−1)” “LTE prefer frequency” corresponds “power saving”, so the weighted priority value PRi′ is “PRi+(bias+N)”. “LTE cell-Game prefer frequency & LTE prefer frequency” corresponds “power saving and game performance”, so the weighted priority values PRi′ is “PRi+(bias+N)+(bias+N−1).”

TABLE II

| | service types STj | |
|---|---|---|
| | corresponding | weighted priority |
| cells CLi | the cells CLi | values PRi' |
| NR cell-Game | game performance | PRi + (bias + N − 1) |
| prefer | | |
| frequency | | |
| LTE prefer | power saving | PRi + (bias + N) |
| frequency | | |
| LTE cell-Game | power saving + game | PRi + (bias + N) + |
| prefer | performance | (bias + N − 1) |
| frequency & | | |
| LTE prefer | | |
| frequency | | |
| . . . | . . . | . . . |

Refer to Table II, the larger the weighted Wj is, the greater the increase to the priority value PRi is. After calculation, the order of the weighted priority values PRi′ may be different from the order of the original priority value PRi.

In another embodiment, the customization favor setting CF could be dynamically set by the user. For example, as shown in the following table III, the customization favor setting CF in the table III is that the game performance is preferred over the power saving.

TABLE III

| customization favor | | service | weighted |
|---|---|---|---|
| setting CF | | types STj | values Wj |
| order | 1 | game performance | +(bias + N) |
| | 2 | power saving | +(bias + N − 1) |
| | 3 | . . . | +(bias + N − 2) |

Then, as shown in the following table IV, “NR cell-Game prefer frequency” corresponds “game performance”, so the weighted priority value PRi′ is “PRi+(bias+N).” “LTE prefer frequency” corresponds “power saving”, so the weighted priority value PRi′ is “PRi+(bias+N−1).” “LTE cell-Game prefer frequency & LTE prefer frequency” corresponds “power saving and game performance”, so the weighted priority value PRi′ is “PRi+(bias+N−1)+(bias+N).”

TABLE IV

| | service types STj | |
|---|---|---|
| | corresponding | weighted priority |
| cells CLi | the cells CLi | values PRi' |
| NR cell- Game | game performance | PRi + (bias + N) |
| prefer | | |
| frequency | | |
| LTE prefer | power saving | PRi + (bias + N − 1) |
| frequency | | |
| LTE cell- | power saving + game | PRi + (bias + N − 1) + |
| Game prefer | performance | (bias + N) |
| frequency & | | |
| LTE prefer | | |
| frequency | | |
| . . . | . . . | . . . |

Based on the steps S141 to S143 described above, the plurality of weighted priority values PRi′ for the plurality of cells CLi could be calculated according to the plurality of service types STj and the customization favor setting CF.

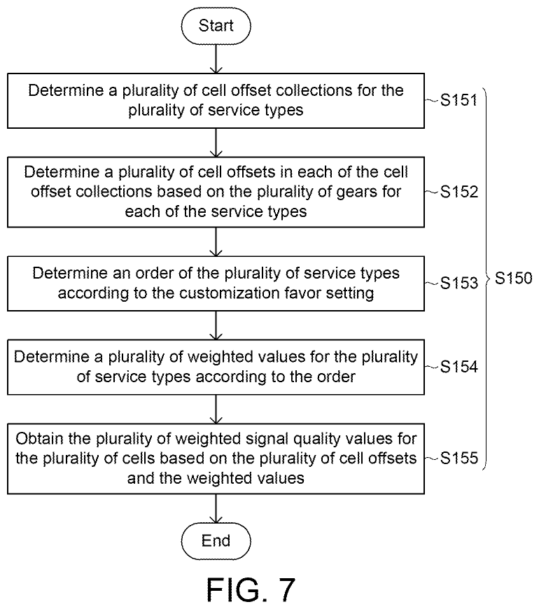

Then, in the step S150 of the FIG. 5B, the signal quality analyzer 150 analyzes and obtains the weighted signal quality values CGi′ for the plurality of cells CLi according to the plurality of service types STj, the plurality of gears GRjk for each of the plurality of service types STj and the customization favor setting CF. FIG. 7 shows a detail flowchart of the step S150. The step S150 includes steps S151 to S155.

In the step S151 of the FIG. 7, as shown in the following tables V and VI, the signal quality analyzer 150 determines a plurality of cell offset collections OSCj for the plurality of service types STj. “cell_offset_collection[0]” and “cell_offset_collection[1]” are two examples of the cell offset collections OFCj. “cell_offset_collection[0]” is for “game performance.” “cell_offset_collection[1]” is for “throughput performance.”

TABLE V
cell_offset_collection[0]

| service types STj | gears GRjk | cell offsets OFjk | |
|---|---|---|---|
| game performance | gaming good cell | +x1 | dBm |
| game performance | gaming normal cell | +0 | dBm |
| game performance | gaming bad cell | −x1 | dBm |

TABLE VI
cell_offset_collection[1]

| service types STj | gears GRjk | cell offsets OFjk | |
|---|---|---|---|
| throughput performance | throughput good cell | +x2 | dBm |
| throughput performance | throughput normal cell | +0 | dBm |
| throughput performance | throughput bad cell | −x3 | dBm |

Then, in the step S152, the signal quality analyzer 150 determines a plurality of cell offsets OFjk in each of the cell offset collections OFCj based on the plurality of gears GRjk for each of the service types STj. For example, as shown in the table V, the cell offsets OFjk in “cell_offset_collection[0]” based on “gaming good cell”, “gaming normal cell” and “gaming bad cell” for “game performance” are “+x1 dBm”, “+0 dBm”, “−x1 dBm.” As shown in the table VI, the cell offsets OFjk in “cell_offset_collection[1]” based on “throughput good cell”, “throughput normal cell” and “throughput bad cell” for “throughput performance” are “+x2 dBm”, “+0 dBm”, “−x3 dBm.”

Next, in the step S153, as shown in the following table VII, the signal quality analyzer 150 determines an order of the plurality of service types STj according to the customization favor setting CF. The customization favor setting CF could be dynamically set by the user. In the example table VII, the customization favor setting CF in the table VII is that the game performance is preferred over the throughput performance.

TABLE VII

| customization | | | weighted |
|---|---|---|---|
| favor setting CF | | service types STj | values Wj |
| order | 1 | game performance | 0.8 |
| | 2 | throughput performance | 0.5 |
| | 3 | . . . | . . . |

Then, in the step S154, as shown in the table VII, the signal quality analyzer 150 determines a plurality of weighted values Wj for the plurality of service types STj according to the order. The plurality of weighted values Wj are different. For example, the weighted value Wj for “game performance” is “0.8”, the weighted value Wj for “throughput performance” is “0.5.” The weighted values Wj are decremented based on the order.

Afterwards, in the step S155, the signal quality analyzer 150 analyzes and obtains the plurality of weighted signal quality values CGi′ for the plurality of cells CLi based on the plurality of cell offsets OFjk and the weighted values Wj. For example, the weighted signal quality value CGi′ for the cell CLi corresponding “game good cell” and “throughput normal cell” is calculated via the following equation (1). The weighted signal quality value CGi′ for the cell CLi corresponding “game bad cell” and “throughput bad cell” is calculated via the following equation (2).

CGi′=CGi+x1*0.8+0*0.5 (1)

Based on the steps S151 to S155 described above, the plurality of weighted signal quality values CGi′ for the plurality of cells CLi could be calculated according to the plurality of service types STj, the plurality of gears GRjk for each of the plurality of service types STj and the customization favor setting CF.

Next, in the step S160 of the FIG. 5B performed in the idle mode, the first controller 160 triggers mobility via the cell reselection which uses the weighted priority values PRi′ or the weighted signal quality values CGi′. For example, when the mobile device MD camps on a NR cell, but the user prefer the power saving purpose, the weighted priority value PRi′ or the weighted signal quality value CGi′ of the LTE frequency/cell would be updated and could be higher than that of the NR frequency/cell. As such, the mobile device MD would select the LTE frequency/cell in the idle mode for satisfying the power saving purpose.

Then, in the step S170 performed in the connected mode, the second controller 170 trigger mobility via measurement reports which are generated based on the weighted signal quality values CGi′. The measurement reports are, for example, A3, A4, A5 reports. For example, when the mobile device MD camps on a NR cell with the best cell signal quality, but the user prefer the throughput performance purpose, the weighted signal quality value CGi′ of the NR frequency/cell with better throughput performance would be updated and could be higher than that of the NR frequency/cell with the best cell signal quality. As such, Network may let the mobile device MD handover to the NR frequency/cell with better throughput performance in the connected mode for satisfying the throughput performance purpose.

Based on the embodiments described above, the user purpose is considered to perform the cell reselection behavior BH1 in the idle mode and to perform the handover behavior BH2 in the connected mode. As such, the mobile device MD could guarantee best user experience.

Moreover, even if the user has multiple purposes, the weighted values Wj could use to consider the multiple purposes at the same time to solve the conflict between the multiple purposes.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for wireless communication, comprising:
judging a plurality of service types for a plurality of cells;
judging a plurality of gears for each of the service types;
obtaining a customization favor setting;
obtaining a plurality of weighted priority values for the plurality of cells according to the plurality of service types and the customization favor setting;
obtaining a plurality of weighted signal quality values for the plurality of cells according to the plurality of service types, the plurality of gears for each of the plurality of service types and the customization favor setting;
in an idle mode, triggering mobility via cell reselection which uses the weighted priority values or the weighted signal quality values; and
in a connected mode, triggering mobility via measurement reports which are generated based on the weighted signal quality values.

2. The method for wireless communication according to claim 1, wherein an order of the plurality of service types is determined according to the customization favor setting, and a plurality of weighted values for the plurality of service types are determined according to the order.

3. The method for wireless communication according to claim 2, wherein the plurality of weighted priority values for the plurality of cells are obtained based on the weighted values.

4. The method for wireless communication according to claim 2, wherein the plurality of weighted values are different.

5. The method for wireless communication according to claim 1, wherein a plurality of cell offset collections for the plurality of service types are determined.

6. The method for wireless communication according to claim 5, wherein a plurality of cell offsets in each of the cell offset collections are determined based on the plurality of gears for each of the service types.

7. The method for wireless communication according to claim 6, wherein an order of the plurality of service types is determined according to the customization favor setting, and a plurality of weighted values for the plurality of service types are determined according to the order.

8. The method for wireless communication according to claim 7, wherein the weighted values are decremental based on the order.

9. The method for wireless communication according to claim 7, wherein the plurality of weighted signal quality values for the plurality of cells are obtained based on the plurality of cell offsets and the weighted values.

10. The method for wireless communication according to claim 6, wherein the plurality of weighted values are different.

11. A wireless modem for wireless communication, comprising:
a service judger, configured to judge a plurality of service types for a plurality of cells and judge a plurality of gears for each of the service types;
a customization center, configured to obtain a customization favor setting;
a priority analyzer, configured to obtain a plurality of weighted priority values for the plurality of cells according to the plurality of service types and the customization favor setting;
a signal quality analyzer, configured to obtain a plurality of weighted signal quality values for the plurality of cells according to the plurality of service types, the plurality of gears for each of the plurality of service types and the customization favor setting;
a first controller, configured to trigger mobility in an idle mode via cell reselection which uses the weighted priority values or the weighted signal quality values; and
a second controller, configured to trigger mobility in a connected mode via measurement reports which are generated based on the weighted signal quality values.

12. The wireless modem for wireless communication according to claim 11, wherein the priority analyzer is further configured to determine an order of the plurality of service types according to the customization favor setting, and further configured to determine a plurality of weighted values for the plurality of service types according to the order.

13. The wireless modem for wireless communication according to claim 12, wherein the priority analyzer is configured to obtain the plurality of weighted priority values for the plurality of cells based on the weighted values.

14. The wireless modem for wireless communication according to claim 12, wherein the plurality of weighted values are different.

15. The wireless modem for wireless communication according to claim 11, wherein the signal quality analyzer is further configured to determine a plurality of cell offset collections for the plurality of service types.

16. The wireless modem for wireless communication according to claim 15, wherein the signal quality analyzer is further configured to determine a plurality of cell offsets in each of the cell offset collections based on the plurality of gears for each of the service types.

17. The wireless modem for wireless communication according to claim 16, wherein the signal quality analyzer is further configured to determine an order of the plurality of service types according to the customization favor setting, and is further configured to determine a plurality of weighted values for the plurality of service types are according to the order.

18. The wireless modem for wireless communication according to claim 17, wherein the signal quality analyzer is configured to obtain the plurality of weighted signal quality values for the plurality of cells based on the plurality of cell offsets and the weighted values.

19. The wireless modem for wireless communication according to claim 16, wherein the plurality of weighted values are different.

20. A mobile device, comprising:
a wireless modem, comprising:
a service judger, configured to judge a plurality of service types for a plurality of cells and judge a plurality of gears for each of the service types;
a customization center, configured to obtain a customization favor setting;
a priority analyzer, configured to obtain a plurality of weighted priority values for the plurality of cells according to the plurality of service types and the customization favor setting;
a signal quality analyzer, configured to obtain a plurality of weighted signal quality values for the plurality of cells according to the plurality of service types, the plurality of gears for each of the plurality of service types and the customization favor setting;
a first controller, configured to trigger mobility in an idle mode via cell reselection which uses the weighted priority values or the weighted signal quality values; and
a second controller, configured to trigger mobility in a connected mode via measurement reports which are generated based on the weighted signal quality values.
